(19) United States
(12) Patent Application Publication
(10) Pub. No.: US 2016/0086491 A1
(43) Pub. Date: Mar. 24, 2016

(54) SYSTEM AND METHOD FOR ASSISTING EMERGENCY SITUATION FOR DRIVERS USING WEARABLE SMART DEVICE

(71) Applicant: HYUNDAI MOTOR COMPANY, Seoul (KR)

(72) Inventor: Byung Sik Choi, Osan-si (KR)

(73) Assignee: HYUNDAI MOTOR COMPANY

(21) Appl. No.: 14/567,864

(22) Filed: Dec. 11, 2014

(30) Foreign Application Priority Data
Sep. 23, 2014 (KR) 10-2014-0127106

(51) Int. Cl. G08G 1/00; B60Q 1/26

(52) U.S. Cl. CPC G08G 1/205; B60Q 1/26

(57) ABSTRACT

The present disclosure provides a system and a method capable of properly supporting a driver by monitoring driver information and vehicle data in real time by linking with a wearable smart device and providing the driver information to a medical center, an emergency center, or an emergency vehicle through a mobile communication network upon an occurrence of an emergency situation of the driver. A system for assisting an emergency situation for drivers using a wearable smart device includes: a vehicle unit configured to process vehicle data, determine an emergency situation of a driver or whether or not an accident of a vehicle occurs, and transmit the emergency situation of the driver to a smart device of a driver of the other vehicle; and a wearable smart device of the driver configured to transmit driver information in the emergency situation detected from information received from the vehicle unit to an emergency center or an emergency vehicle which is positioned in vicinity of the driver in the emergency situation.

### CROSS-REFERENCE TO RELATED APPLICATION

This application is based on and claims the benefit of priority to Korean Patent Application No. 10-2014-0127106, filed on Sep. 23, 2014 in the Korean Intellectual Property Office, the disclosure of which is incorporated herein in its entirety by reference.

### TECHNICAL FIELD

The present disclosure relates to a system and a method for assisting an emergency situation for drivers using a wearable smart device, and more particularly, to a technology for detecting a state of a driver by linking with a smart device and providing a warning.

### BACKGROUND

An emergency situation such as a traffic accident or a shoulder road parking occurring on a highway, or the like may cause another emergency situation such as a secondary accident in the case in which the emergency situation is not informed to a vehicle which is to enter an occurrence location of the emergency situation, or the like using a suitable method. In the case in which the traffic accident occurs on the highway, an occurrence of the traffic accident is limitedly informed by an electronic display installed at a predetermined location of the highway, traffic broadcasting, or the like. Since the electronic displays capable of informing the emergency situation are insufficiently installed to such an extent as to cover only some sections of the entire section of the highway, it is basically impossible to inform the traffic accident of drivers in sections in which the electronic displays are not installed. Even though the traffic accident occurs in the section in which the electronic display is installed, a driver of a following vehicle may overlook the emergency situation which is informed by the electronic display and may not recognize the emergency situation due to deteriorating weather conditions such as fog occurrence, or the like. In addition, the information of the traffic accident using the traffic broadcasting has limited effect due to various influences such as a limitation in channels, a limitation in time, and the like. In informing the emergency situation using the electronic display or the traffic broadcasting, since an occurrence of various situations such as a shoulder road parking is the emergency situation, it may cause another emergency situation.

### SUMMARY

An aspect of the present disclosure provides a system and a method capable of properly supporting a driver by monitoring driver information and vehicle data in real time by linking with a wearable smart device and providing the driver information to a medical center, an emergency center, or an emergency vehicle through a mobile communication network upon an occurrence of an emergency situation of the driver.

Other objects and advantages of the present disclosure can be appreciated by the following description and will be clearly described by the exemplary embodiments of the present invention. It will be easily known that the objects and advantages of the present disclosure can be implemented by means and a combination thereof shown in the appended claims.

According to an exemplary embodiment of the present disclosure, a system for assisting an emergency situation for drivers using a wearable smart device includes a vehicle unit configured to process vehicle data, determine an emergency situation of a driver, and transmit the emergency situation of the driver to a smart device of a driver of the other vehicle; and a wearable smart device of the driver configured to transmit driver information in the emergency situation detected from information received from the vehicle unit to an emergency center or an emergency vehicle which is positioned in vicinity of the driver in the emergency situation.

The vehicle data may include vehicle driving information, vehicle accident information, and driver information.

The vehicle unit may transmit and receive data with infra (V2X) and the vehicle data to and from the other vehicle.

The smart device may include a smart phone, a smart watch, a smart glass, a smart bracelet, and a smart necklace.

The smart device may process status information of the driver for each step of normal, caution or risk and inform the emergency center or the smart device of the driver of the other vehicle of the status information.

The smart device may transmit the driver information to a medical center, the emergency center, or the emergency vehicle through a mobile communication network.

The smart device may detect biometric information including heart rate, pulse, and body temperature of the driver from a sensor which is embedded.

The emergency situation includes an occurrence of an accident at the vehicle.

According to another exemplary embodiment of the present disclosure, a method for assisting an emergency situation for drivers using a wearable smart device includes: warning, by a vehicle unit included in a vehicle, an emergency situation of a driver or an accident of the vehicle when the emergency situation of the driver or the accident of the vehicle occurs; transmitting, by the vehicle unit, the emergency situation of the driver, and vehicle data of the wearable smart device of the driver; and transmitting, by the smart device, the driver information to an emergency center or an emergency vehicle which is position in vicinity of the smart device.

The smart device may process status information of the driver for each step of normal, caution or risk and inform the status information of a smart device of a driver of the other vehicle.

After the warning of the emergency situation of the driver or the accident of the vehicle, the vehicle unit may transmit the emergency situation of the driver, the accident occurrence information of the vehicle or the vehicle data to a smart device of a driver of the other vehicle.

The emergency situation includes an occurrence of an accident at the vehicle.

### BRIEF DESCRIPTION OF THE DRAWINGS

The above and other objects, features and advantages of the present disclosure will be more apparent from the following detailed description taken in conjunction with the accompanying drawings.

FIG. 1 is a diagram illustrating a system for assisting an emergency situation for drivers using a wearable smart device according to an exemplary embodiment of the present disclosure.

### DETAILED DESCRIPTION

The above-mentioned objects, features, and advantages will become obvious from the detailed description which is described below in detail with reference to the accompanying drawings. Therefore, those skilled in the art to which the present disclosure pertains may easily practice a technical idea of the present disclosure. Further, in describing the present disclosure, in the case in which it is judged that a detailed description of a well-known technology associated with the present disclosure may unnecessarily make unclear the gist of the present disclosure, it will be omitted. Hereinafter, exemplary embodiments of the present disclosure will be described in detail with reference to the accompanying drawings.

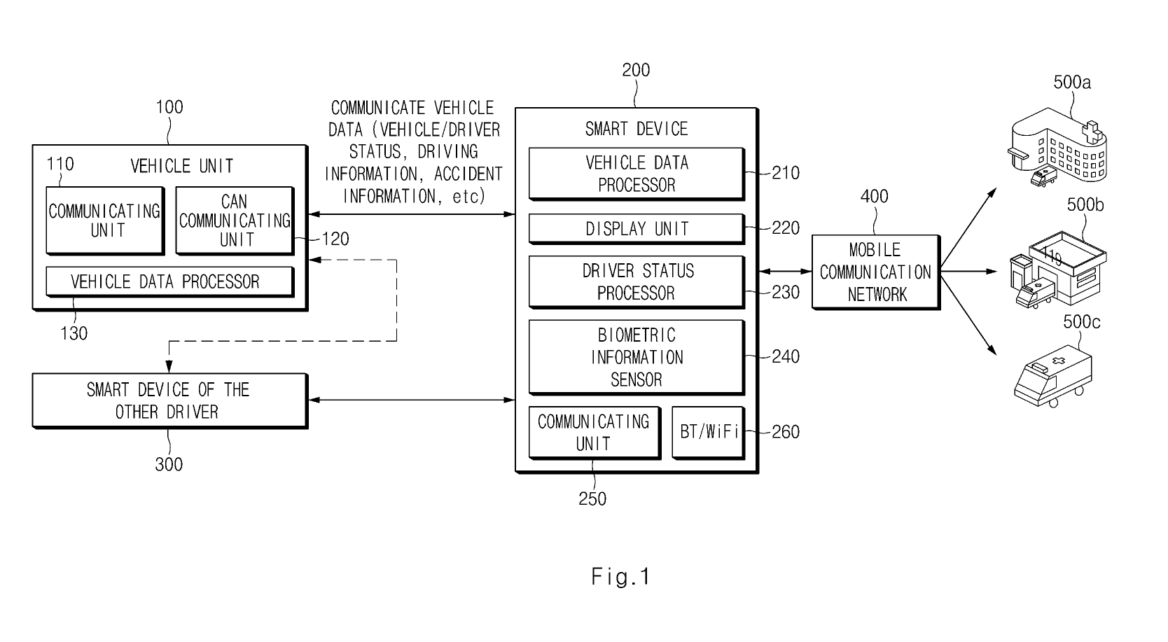

FIG. 1 is a diagram illustrating a system for assisting an emergency situation for drivers using a wearable smart device according to an exemplary embodiment of the present disclosure.

Referring to FIG. 1, a vehicle unit 100 includes a communicating unit 110, a connectivity access network (CAN) communicating unit 120, and a vehicle data processor 130.

The communicating unit 110 may receive accident warning information transmitted from the other vehicle through communication with the other vehicle when an accident occurs at a front of a driving direction of an own vehicle, may transmit vehicle data processed by the vehicle data processing unit 130 to a wearable smart device 200 of the driver, and may transmit and receive the vehicle data to and from a smart device 300 of another driver. In addition, the communicating unit 110 may transmit and receive data with a road or traffic infra (V2X) through the communication with the other vehicle.

The CAN communicating unit 120 may receive vehicle driving information, driver status information, and the like through a variety of sensors in the vehicle.

The vehicle data processor 130 processes the vehicle data received from the communicating unit 110 or the CAN communicating unit 120 in order to determine whether or not an emergency situation of the driver or an accident of the vehicle occurs.

Here, the vehicle data may include vehicle driving information, vehicle accident and risk information, information about whether or not an accident of a front vehicle or the other vehicle occurs, and driver status information.

The vehicle driving information may include vehicle velocity, an steering angle, whether or not a brake switch is operated, global positioning system (GPS) information, yaw rate information, acceleration sensor information, whether or not an engine is operated, tire pressure monitoring system (TPMS) warning information, vehicle door open or close information, information about whether a seat belt is fastened, and the like.

The vehicle accident and risk information may include whether or not an air bag is unfolded, whether or not active and pedestrian hoods are unfolded, impact sensor information, dedicated short range communications (DSRC) communication information, and the like.

The information about whether or not the accident of the front or the other vehicle occurs may include accident warning information transmitted from the other vehicle when the accident occurs at the front of the driving direction of the own vehicle.

The driver status information may include information on a driver's eye tracking sensor or a driver status monitoring (DSM) camera sensor. The DSM camera sensor information may include information on a driver's eyes and drowsy driving.

The above-mentioned vehicle unit 100 may inform the emergency situation of the driver or whether or not the accident of the vehicle occurs using the vehicle data of the driver as a warning message or a warning sound through a display or a speaker of the vehicle unit 100.

The wearable smart device 200 of the driver includes a vehicle data processor 210, a display 220, a driver status processor 230, a biometric information sensor 240, a communicating unit 250, and Bluetooth/WiFi 260.

The vehicle data processor 210 may receive the emergency situation of the driver or whether or not the accident of the vehicle occurs by using the vehicle data received from the vehicle unit or the smart device connected to the vehicle unit may directly determine the emergency situation of the driver or whether or not the accident of the vehicle occurs. Here, the wearable smart devices of the driver, which are devices including a smart glass, a smart watch, and the like, may include a device which is directly wearable by the driver and may more accurately measure status information of a user such as a heart rate, blood pressure, body temperature, and the like in real time.

The display 220 may additionally inform the emergency situation so that the driver receives a vibration warning or a warning message.

The driver status processor 230 may detect status information of the driver (information for each step such as normal/caution/risk, or the like).

The biometric information sensor 240 may detect biometric information such as heart rate, pulse, body temperature, and the like which are collected from a sensor embedded in the wearable smart device of the driver.

The communicating unit 250 may inform the driver information of a medical center 500a, an emergency center 500b or an emergency vehicle 500c which is positioned in vicinity of the driver in the emergency situation using the mobile communication network 400, or may transmit or receive information including whether or not the accident occurs, a warning information, an accident occurring position, and time information to or from the smart device 300 of the other driver. The information including whether or not the accident occurs, the warning information, and the like may be transmitted to the smart device 300 of the other driver using a communication modem of the communicating unit 250, the Bluetooth/WiFi 260, or the like.

The driver may get first aid in advance before the driver arrives at the medical center and the emergency center or the emergency vehicle arrives by transmitting the driver information to the medical center, the emergency center, or the emergency vehicle which is a short distance away so that the first aid may be given to the driver according to a damage degree of the driver in the accident vehicle after the emergency situation of the driver or the accident of the vehicle.

Here, the driver information may include whether or not the driver moves in the vehicle and movement information. In addition, the driver information may include profile information of the driver (name, gender, age, address, email, telephone number, and the like) by which basic information of the driver may be checked.

The above-mentioned driver information may be wirelessly transmitted to the medical center, the emergency center, or the emergency vehicle using an external mobile communication network 400 through the communicating unit 250 or the Bluetooth/WiFi 260 embedded in the wearable smart device 200 of the driver. The above-mentioned driver information in the accident vehicle may be continuously transmitted at a predetermined period once the accident occurs, and may change a transmission period thereof according to the status information and biometric information of the driver. That is, in the case in which the collected heart rate, pulse, body temperature, and the like among the driver information in the accident vehicle drop below a reference value, it is determined that the emergency situation occurs, such that the driver information may be adjusted to have a short transmission period and may be then transmitted to the medical center, the emergency center, or the emergency vehicle.

A method for assisting an emergency situation for drivers using a wearable smart device according to an exemplary embodiment of the present disclosure will be described in detail.

The vehicle unit 100 of the vehicle may classify the emergency situation of the vehicle as follows in order to determine the emergency situation of the driver.

First, the emergency situation of the vehicle may be classified into warning steps including a rear-end warning due to a quick braking of a front vehicle, a lane departure warning, an overspeed section warning, a warning due to attention dispersion of the driver, and the like.

The above-mentioned warning steps may transmit the warning message and the warning sound to the driver through a display, a speaker, or the like of the vehicle unit 100 in the own vehicle in a situation such as the quick braking of the front vehicle or the lane departure. By adding the vibration warning utilizing the wearable smart device 200 of the driver in order to transmit the warning message and the warning sound to the driver, the driver may more directly recognize the emergency situation.

Next, the emergency situation of the vehicle may be classified into a vehicle accident occurrence step in which rear-end or collision accident between vehicles, or between the vehicle and pedestrian, or directly between the vehicle and other structures may occur.

In the vehicle accident occurrence step, in order to minimize secondary damage immediately after vehicle collision, accident information is transmitted to the other vehicle in a predetermined distance range from an accident point, such that whether or not the accident occurs may be warned through the smart device 200 worn by the driver of the other vehicle and whether or not the accident occurs may be checked.

In the warning step, the vehicle data collected by the vehicle unit 100 may be linked to the communicating unit 250 or a communication device which is embedded in the wearable smart device 200 of the driver and may be transmitted to the other vehicle or the smart device 300 of the driver of the other vehicle. Specifically, the information transmitted to the other vehicle may include whether or not the accident occurs, the accident occurrence position, and the time information.

Next, the emergency situation of the vehicle may be classified into a step after the vehicle accident occurrence capable of predicting a damage degree of the driver including the heart rate, pulse, body temperature, motion, or the like of the driver.

After the vehicle accident occurrence, the driver may get first aid in advance before the driver arrives at the medical center 500a and the emergency center 500b or the emergency vehicle 500c arrives by transmitting the driver information to the medical center 500a, the emergency center 500b, or the emergency vehicle 500c which is a short distance away so that first aid may be got according to a damage degree of the driver in the accident vehicle.

In addition, the driver information may include status information of the driver (information for each step such as normal/caution/risk, or the like) and the biometric information such as the heart rate, pulse, body temperature, and the like which are collected from the sensor embedded in the wearable smart device 200 of the driver.

In addition, the driver information may include whether or not the driver moves in the vehicle and movement information. In addition, the driver information may include profile information of the driver (name, gender, age, address, email, telephone number, and the like) by which basic information of the driver may be checked.

As describe above, according to the exemplary embodiment of the present disclosure, the driver may be properly supported by monitoring driver information and vehicle data in real time by linking with a wearable smart device and providing the driver information to a medical center, an emergency center, or an emergency vehicle through a mobile communication network upon an occurrence of an emergency situation of the driver.

In addition, according to the exemplary embodiment of the present disclosure, an occurrence of another accident may be avoided in advance by sharing accident occurrence information with adjacent vehicles when a vehicle accident occurs.

In addition, according to the exemplary embodiment of the present disclosure, proper first aid may be performed by detecting status and damage degree of the driver from the driver information which is collected from the wearable smart device of the driver.

Although the present disclosure has been described with reference to exemplary embodiments and the accompanying drawings, it would be appreciated by those skilled in the art that the scope of the present disclosure is not limited thereto but various modifications and alterations might be made without departing from the scope defined in the claims and their equivalents.

What is claimed is:

1. A system for assisting an emergency situation for drivers using a wearable smart device, the system comprising:
a vehicle unit configured to process vehicle data, determine an emergency situation of a driver, and transmit the emergency situation of the driver to a smart device of a driver of the other vehicle; and
a wearable smart device of the driver having the emergency situation configured to transmit driver information in the emergency situation detected from information received from the vehicle unit to an emergency center or an emergency vehicle which is positioned in vicinity of the driver in the emergency situation.

2. The system according to claim 1, wherein the vehicle data includes vehicle driving information, vehicle accident information, and driver information.

3. The system according to claim 1, wherein the vehicle unit transmits and receives data with infra (V2X) and the vehicle data to and from the other vehicle.

4. The system according to claim 1, wherein the smart device includes a smart phone, a smart watch, a smart glass, a smart bracelet, and a smart necklace.

5. The system according to claim 1, wherein the smart device processes status information of the driver for each step of normal, caution or risk and informs the status information of the emergency center or the smart device of the driver of the other vehicle.

6. The system according to claim 1, wherein the smart device transmits the driver information to a medical center, the emergency center, or the emergency vehicle through a mobile communication network.

7. The system according to claim 1, wherein the smart device detects biometric information including heart rate, pulse, and body temperature of the driver from a sensor which is embedded.

8. The system according to claim 1, wherein the emergency situation includes an occurrence of the accident at the vehicle.

9. A method for assisting an emergency situation for drivers using a wearable smart device, the method comprising:
warning, by a vehicle unit included in a vehicle, an emergency situation of a driver or an accident of the vehicle when the emergency situation of the driver occurs;
transmitting, by the vehicle unit, the emergency situation of the driver, and vehicle data to the wearable smart device of the driver; and
transmitting, by the smart device, the driver information to an emergency center or an emergency vehicle which is position in vicinity of the smart device.

10. The method according to claim 9, wherein the smart device processes status information of the driver for each step of normal, caution or risk and informs the status information of a smart device of a driver of the other vehicle.

11. The method according to claim 9, wherein after the warning of the emergency situation of the driver, the vehicle unit transmits the emergency situation of the driver, the accident occurrence information of the vehicle or the vehicle data to a smart device of a driver of the other vehicle.

12. The method according to claim 9, wherein the emergency situation includes an occurrence of the accident at the vehicle.
